(19) United States
(12) Patent Application Publication
(10) Pub. No.: US 2022/0147645 A1
(43) Pub. Date: May 12, 2022

(54) METHOD, APPARATUS, AND SYSTEM FOR DISCOVERING PRIVATE DATA USING CONFIGURABLE RULES

(71) Applicant: IOR Analytics, LLC, Houston, TX (US)

(72) Inventors: Matthew Michael LINDE, Houston, TX (US); Max MONTES, Houston, TX (US); Daniel KIM, Houston, TX (US); Erik WELLS, Holly Springs, NC (US)

(21) Appl. No.: 17/096,695

(22) Filed: Nov. 12, 2020

(51) Int. Cl. G06F 21/62; G06F 40/284; G06F 40/163; G06F 40/16; G06N 20/00; G06F 21/60

(52) U.S. Cl. CPC G06F 21/6227; G06F 40/284; G06F 21/602; G06F 40/16; G06N 20/00; G06F 40/163

(57) ABSTRACT

An approach is disclosed for generating an adjustable ruleset for fingerprinting data. The approach involves, for example, designating a data type as private. The approach also involves collecting private data relating to user from one or more data sources, wherein the private data includes a plurality of attributes that include a private attribute having the private data type. The approach further involves transforming the private attribute based on one or more configured rules for tokenizing the private attribute. The approach also involves generating a token corresponding to transformed private attribute; and initiating storage of the token for subsequent discovery of data having the private data type.

### BACKGROUND

User data privacy and protection (e.g., consumer, employee, etc.) have been a growing area of concern, resulting in the global promulgation of data protection laws. These laws as well as maturing trends in information security have placed ever increasing burdens on organizations to provide the best possible protection of individual data and to allow individuals the right to request their own data be forgotten. To accomplish this, an organization must maintain accurate knowledge about the private data they accumulate as processes and technology evolve over time. Traditionally, the inaccuracies in the available data searching and tracking processes, which are based on hardcoded rules, make the assessment of privacy protection measures technically difficult and expensive. That is, for an organization to routinely assess its privacy protection measures for ensuring compliance requires an enormous investment in time and resources, even if viable technical solutions can be implemented.

### SOME EXAMPLE EMBODIMENTS

Therefore, there is a need for a flexible, effective approach for identifying private data using configurable rules.

According to one embodiment, a method comprises designating a data type as private. The method also comprises collecting private data relating to a user from one or more data sources, wherein the private data includes a plurality of attributes that include a private attribute having the private data type. The method also comprises transforming the private attribute based on one or more configured rules for tokenizing the private attribute. The method further comprises generating a token corresponding to the transformed private attribute; and initiating storage of the token for subsequent discovery of data having the private data type.

According to another embodiment, an apparatus comprising at least one processor, and at least one memory including computer program code, the at least one memory and the computer program code configured to, with the at least one processor, cause the apparatus to designate a data type as private. The apparatus is also caused to collect private data relating to a user from one or more data sources, wherein the private data includes a plurality of attributes that include a private attribute having the private data type. The apparatus is also caused to transform the private attribute based on one or more configured rules for tokenizing the private attribute. The apparatus is further caused to generate a token corresponding to the transformed private attribute; and initiate storage of the token for subsequent discovery of data having the private data type.

According to another embodiment, a system comprises one or more servers configured to designate a data type as private. The one or more servers are also configured to collect private data relating to a user from one or more data sources, wherein the private data includes a plurality of attributes that include a private attribute having the private data type. The one or more servers are also caused to transform the private attribute based on one or more configured rules for tokenizing the private attribute. The one or more servers are further caused to generate a token corresponding to the transformed private attribute; and to initiate storage of the token for subsequent discovery of data having the private data type.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system for fingerprinting data based on configurable rules, according to one embodiment;

FIG. 2 is a diagram of the components of the private data discovery platform, according to one embodiment;

FIGS. 3A and 3B are flowcharts of a process for generating an adjustable ruleset for tokenization as part of fingerprinting data, and of a process for data discovery, according to various embodiments;

FIG. 4 is a flowchart of a process for configuring rules to tokenize private data, according to one embodiment;

FIGS. 5A and 5B are flowcharts of a process for selecting configured rule(s) based on confidentiality level, and of a process for creating a new configured rule using an artificial intelligence engine, according to various embodiments;

FIG. 6 is a diagram that shows a use case for the processes of FIGS. 3A and 3B, according to various embodiments;

FIGS. 7A and 7B are diagrams that illustrate two use cases for private data transformation, according to various embodiments;

FIG. 7C is a diagram of a user interface that provides the data types for rules configuration, according to various embodiments;

FIG. 7D is a diagram of a user interface that supports configuration of a ruleset for tokenization, according to various embodiments;

FIG. 8 is a diagram of hardware that can be used to implement an embodiment;

FIG. 9 is a diagram of a chip set that can be used to implement an embodiment; and

FIG. 10 is a diagram of a mobile station (e.g., handset) that can be used to implement an embodiment.

### DESCRIPTION OF PREFERRED EMBODIMENT

Examples of a method, apparatus, and system for generating and utilizing an adjustable ruleset for fingerprinting data are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

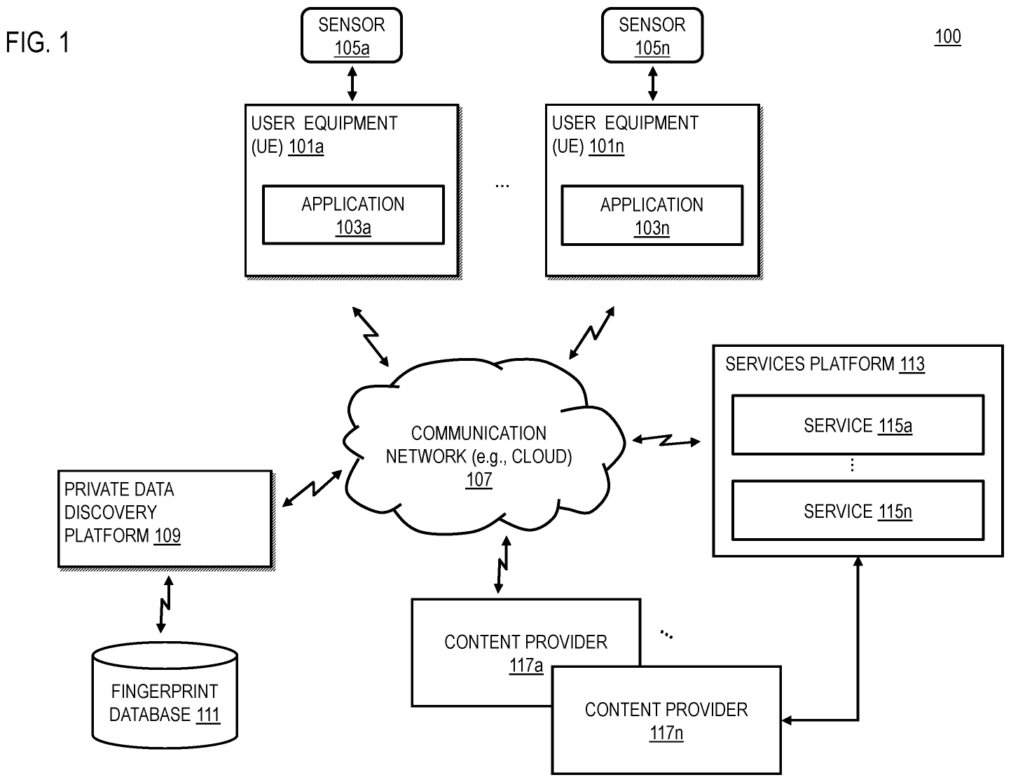

FIG. 1 is a diagram of a system for fingerprinting data based on configurable rules, according to one embodiment. System 100 provides a capability to “fingerprint” data that is intended to be private for later discovery; that is, such data can be identified and uniquely labeled for comparison and searching by various data discovery methods. In this manner, system 100 efficiently processes through voluminous data to identify and extract private data without requiring costly analysis of the data by humans. To better appreciate this capability, a traditional process for “fingerprinting” is explained as follows.

State of the art approaches permit, in general, the storage of known data for later comparison—which is considered “fingerprinting” data. Typically, such conventional fingerprinting simply consumes data in textual/tabular information, in which non-alphanumeric information (e.g., punctuation, etc.) is extracted from the text. Subsequently, the resulting data is transformed or obfuscated (e.g., hashed) and then stored for later search and/or comparison; this can occur when the data is scanned for sensitive information across an organization's network. However, this conventional process is fixed and is not modifiable for various types of data. For instance, the importing process of the data in which the data is modified to remove characters and hashed is based on hardcoded rules. Consequently, little to no flexibility is provided in transforming the data for storage and later search because of these hardcoded rules. Additionally, data management based on hardcoded rules are error-prone. By way of example, the subject data can be part of an invoice, which includes a dollar amount, e.g., $12,345.67; this data associated with the invoice can be erroneously matched to a different data record, such as a medical record number, i.e., 1234567, of an individual. In practice, such error creates numerous erroneous incidents, wastes a tremendous about of man-hours in data analysis, as well as resulting in a customer losing confidence in the organization's service.

To address this problem, the private data discovery system 100 introduces the capability to generate an adjustable (or configurable) ruleset for fingerprinting data. System 100 provides a unique process for fingerprinting private data for comparison and searching using state-of-the-art data discovery techniques. According to one embodiment, system 100 provides a fine-tuned (adjustable) ruleset to standardize known data associated with a user (or individual) into a secure and tokenized form for future comparison with discovered data in a fully automated manner—e.g., without intervention of a human agent in the data analysis. This approach advantageously provides a significant improvement over the traditional data analysis systems, which largely produce poor quality results that require costly manual human effort to analyze the data for proper treatment. System 100, by contrast, analyzes the collected data to filter out inaccurate data, and identify known matches by comparing against a repository of known accurate information, thereby overcoming many of the identified errors in the conventional approaches.

As shown in FIG. 1, system 100 also comprises user equipment (UE) 101a-101n (collectively referred to as UE 101) that may include or be associated with applications 103a-103n (collectively referred to as applications 103) and sensors 105a-105n (collectively referred to as sensors 105). In one embodiment, the UE 101 has connectivity to a private data discovery platform 109 via a communication network 107, e.g., a wireless communication network; this can be considered an enterprise network (e.g., within a single network domain or administration). In one embodiment, the private data discovery platform 109 performs one or more functions associated with generating an adjustable ruleset for fingerprinting data by applying artificial intelligence (AI) models.

In one embodiment, the UE 101 may include, but is not restricted to, any type of a mobile terminal, wireless terminal, fixed terminal, or portable terminal. Examples of the UE 101, may include, but are not restricted to, a mobile handset, a wireless communication device, a station, a unit, a device, a multimedia computer, a multimedia tablet, an Internet node, a communicator, a desktop computer, a laptop computer, a notebook computer, a netbook computer, a tablet computer, a Personal Communication System (PCS) device, a personal navigation device, a Personal Digital Assistant (PDA), a digital camera/camcorder, an infotainment system, a dashboard computer, a television device, or any combination thereof, including the accessories and peripherals of these devices, or any combination thereof. In addition, the UE 101 may facilitate various input means for receiving and generating information, including, but not restricted to, a touch screen capability, a keyboard, and keypad data entry, a voice-based input mechanism, and the like. Any known and future implementations of the UE 101 may also be applicable.

With respect to applications 103, these may include various applications such as, but not restricted to, content provisioning application, networking application, calendar applications, camera/imaging application, multimedia application, location-based application, and the like. In one example embodiment, the application 103 enables the private data discovery platform 109 to process content information, communication information, contextual information, and/or sensor information to determine relevant goals and related contextual information for at least one user.

The system 100 also includes one or more sensors 105, which can be implemented, embedded or connected to the UE 101. The sensors 105 may be any type of sensor, e.g., a network detection sensor for detecting wireless signals or receivers for different short-range communications (e.g., Bluetooth, Wi-Fi, Li-Fi, Near Field Communication (NFC), etc.), temporal information sensors, and the like.

Further, various elements of the system 100 may communicate with each other through a communication network 107. The communication network 107 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including 5G (5th Generation), 4G, 3G, 2G, Long Term Evolution (LTE), enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

In one embodiment, the private data discovery platform 109 may be a platform with multiple interconnected components. The private data discovery platform 109 may include one or more servers, intelligent networking devices, computing devices, components and corresponding software for generating an adjustable ruleset for fingerprinting data. In addition, it is noted that the private data discovery platform 109 may be a separate entity of the system 100, a part of the one or more services 115a-115n (collectively referred to as services 115) of the services platform 113, or the UE 101.

The private data discovery platform 109 enables accurate fingerprinting of data, thereby allowing discovery tools to more accurately automate validation of known private data. The accuracy can be configured for individual data types as situations dictate or per customer preferences. Instead of using a hard-coded one-size-fits-all approach, the private data discovery platform 109 creates a User Interface (UI) and repository of configurable rulesets that users (e.g., engineers, system administrators, etc.) can specify. In another embodiment, the rules may be configured organically over time by machine learning or other artificial intelligence (AI) algorithms.

In one embodiment, the private data discovery platform 109 presents, via a graphical user interface (GUI) of any one of UE 101a-101n, a prompt to specify a configured rule for transforming data. In another embodiment, the private data discovery platform 109 retrieves a string of one or more characters. The string includes private information; as used herein, “private information” includes sensitive, confidential data, or any data requiring permission to access the data. The private data discovery platform 109 modifies the string according to the configured rule. The private data discovery platform 109 generates a token using the modified string. The private data discovery platform 109 applies, according to one embodiment, a transformation function to the modified string to generate the token. The transformation function can include a hash function, encryption, or other obfuscation. Thereafter, the private data discovery platform 109 stores the token for the modified string.

In the case of a search or discovery of the stored data, the private data discovery platform 109 generates another token using the modified target string. Upon retrieving the original token, the private data discovery platform 109 compares this token with the other token to determine whether a match exists between the tokens.

The services platform 113 may include any type of service. By way of example, the services platform 113 may include content (e.g., audio, video, images, etc.) provisioning services/application, application services/application, contextual information determination services/application, notification services/application, storage services/application, social networking services/application, etc. In one embodiment, the services platform 113 may interact with the UE 101, the private data discovery platform 109, and the content provider 117 to supplement or aid in the processing of the content information. In one embodiment, the services platform 113 may be implemented or embedded in the private data discovery platform 109 or in its functions.

By way of example, the services 115 may be an online service that reflects the interests and/or activities of users. The services 115 allow users to share contact information, location information, activities information, confidential information, contextual information, historical user information, and interests within their individual networks, and provides for data portability. Such information may be deemed private data by the user or the services 115. The services 115 may additionally assist in providing the private data discovery platform 109 with activity information of at least one user, user profile information, and a variety of additional information.

The content providers 117a-117n (collectively referred to as content provider 117) may provide content to the UE 101, the private data discovery platform 109, fingerprint database 111, and the services 115 of the services platform 113. The content provided may be any type of content, such as, textual content, image content, audio content, video content, etc. In one embodiment, the content provider 117 may provide content that may supplement the content of the applications 103, the sensors 105, fingerprint database 111, or a combination thereof. In one embodiment, the content provider 117 may provide or supplement the content (e.g., audio, video, images, etc.) provisioning services/application, storage services/application, contextual information determination services/application, notification services/application, social networking services/application, location based services/application, or any combination thereof. In one embodiment, the content provider 117 may also store content associated with the UE 101, the private data discovery platform 109, and the services 115 of the services platform 113. In another embodiment, the content provider 117 may manage access to a central repository of data, and offer a consistent, standard interface to data. Any known or still developing methods, techniques or processes for generating an adjustable ruleset for fingerprinting data may be employed by the private data discovery platform 109.

By way of example, the UE 101, private data discovery platform 109 communicate with each other and other components of the communication network 107 using well known, new or still developing protocols. In this context, a protocol includes a set of rules defining how the network nodes within the communication network 107 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

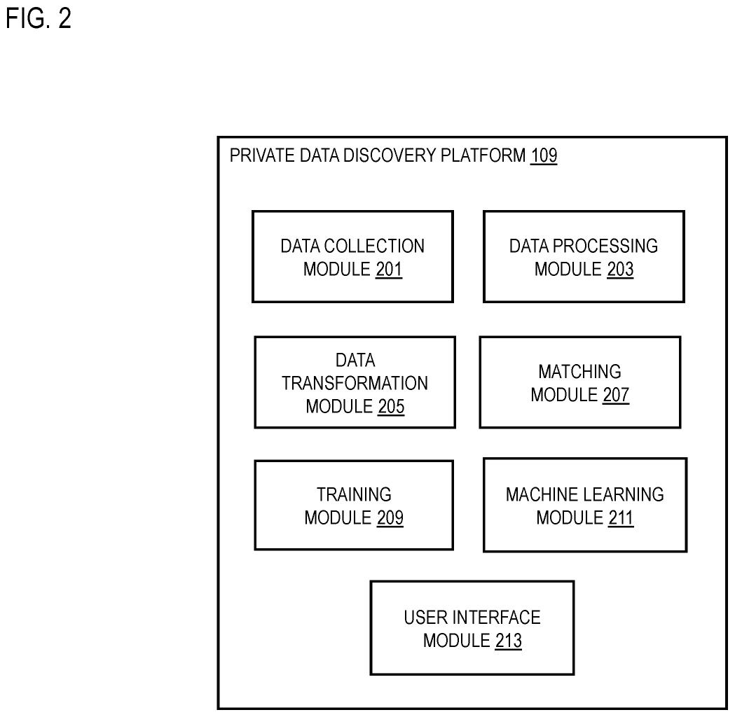

FIG. 2 is a diagram of the components of private data discovery platform 109, according to one embodiment. By way of example, the private data discovery platform 109 includes one or more components for generating an adjustable ruleset for fingerprinting data. It is contemplated that the functions of these components may be combined in one or more components or performed by other components of equivalent functionality. In this embodiment, the private data discovery platform 109 includes a data collection module 201, a data processing module 203, a data transformation module 205, a matching module 207, a training module 209, and a machine learning module 211.

In one embodiment, the data collection module 201 is configured to collect and/or store data pertaining to a user by querying the plurality of sources, e.g., a third-party database (not shown). In one example embodiment, the data collection module 201 may use a web-crawling component or a scanner to access various databases and/or websites or data repository on the Internet to collect data associated with the user. It is contemplated that the scanner can be provided as part of the platform 109 or by an external device (e.g., third party product). The data collection module 201 can collect data in any form, including but not limited to, textual, graphical, photographic, sound, speech, image, video, multimedia, and etc. Thereafter, the collected data may be stored in a data repository, e.g., fingerprint database 111.

In one embodiment, the data processing module 203 automatically processes the data collected by the data collection module 201 to generate, via a hashing scheme, hash values corresponding to one or more attributes of the collected data. The hashing scheme is a transformation that takes an input string and returns a value, i.e., hash value. In another embodiment, the data processing module 203 is configured to perform command-specified data processing operations, e.g., labeling, classification, and analysis, on the collected data. In a further embodiment, the data processing module 203 facilitates automatically ascertaining at least one pattern from the collected data, at least in part, by applying one or more statistical, data-mining, or machine-learning techniques.

In one embodiment, the data transformation module 205 removes certain characters, e.g., outer whitespace characters, inner whitespace characters, punctuation, etc. from the processed data. In another embodiment, the data transformation module 205 may decrypt, encrypt, and/or reformat processed data. In a further embodiment, the data transformation module 205 may perform text manipulation by: changing the case of the characters of a string, removing one or more characters, removing one or more signs, replacing one or more characters, replacing one or more signs, or a combination thereof. In another embodiment, the data transformation module 205 may convert the processed data into tokens (e.g., hash values) based on the configured rules.

In one embodiment, the matching module 207 compares, via data fingerprinting, the tokens (e.g., hash values) of the collected data. If there are no collisions of hash values, then the identification of matching hash values equates to an identification of matching information items between the collected data.

In one embodiment, the training module 209 trains the machine learning module 211 to generate a ruleset to automatically find, compare, and match data, e.g., private data, to improve data accuracy and data validation. In one instance, the training module 209 can continuously provide and/or update the machine learning module 211 during training using, for instance, artificial intelligence (AI) processes, e.g., a machine learning or deep learning, or equivalents on the ingested aggregated data.

In one embodiment, the user interface module 213 may generate a user interface element to specify the configured rule for transforming the collected data. In one embodiment, the user interface module 213 employs various application programming interfaces (APIs) or other function calls corresponding to the application 103 of UE 101; thus enabling the display of graphics primitives such as menus, data entry fields, etc., for generating the user interface elements. Still further, the user interface module 213 may be configured to operate in connection with augmented reality (AR) processing techniques, wherein various different applications, graphic elements, and features may interact.

The above presented modules and components of the private data discovery platform 109 can be implemented in hardware, firmware, software, or a combination thereof. Though depicted as a separate entity in FIG. 1, it is contemplated that the private data discovery platform 109 may be implemented for direct operation by respective UE 101. As such, the private data discovery platform 109 may generate direct signal inputs by way of the operating system of the UE 101 for interacting with the applications 103. In another embodiment, one or more of the modules 201-213 may be implemented for operation by respective UEs 101a-101n, as the private data discovery platform 109, or combination thereof. Still further, the private data discovery platform 109 may be integrated for direct operation with the services 115, such as in the form of a widget or applet, in accordance with an information and/or subscriber sharing arrangement. The various executions presented herein contemplate any and all arrangements and models.

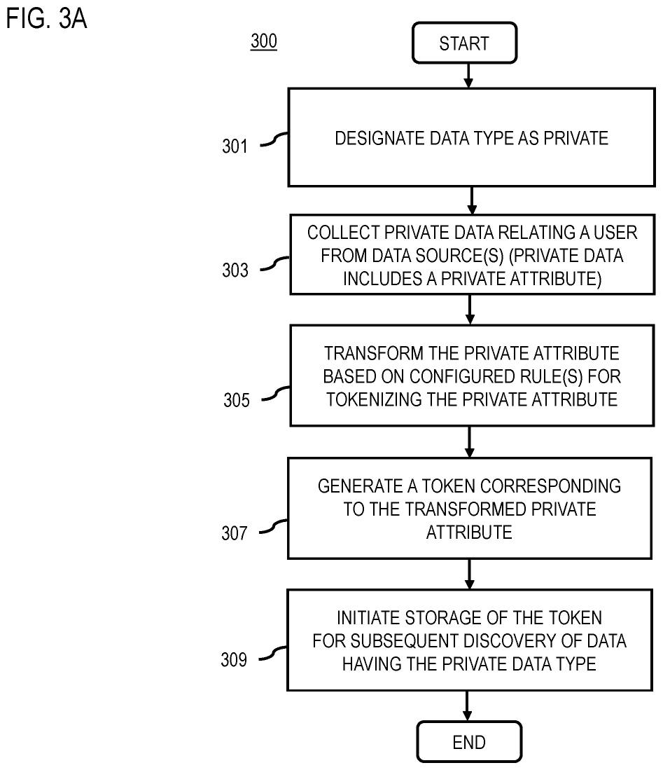

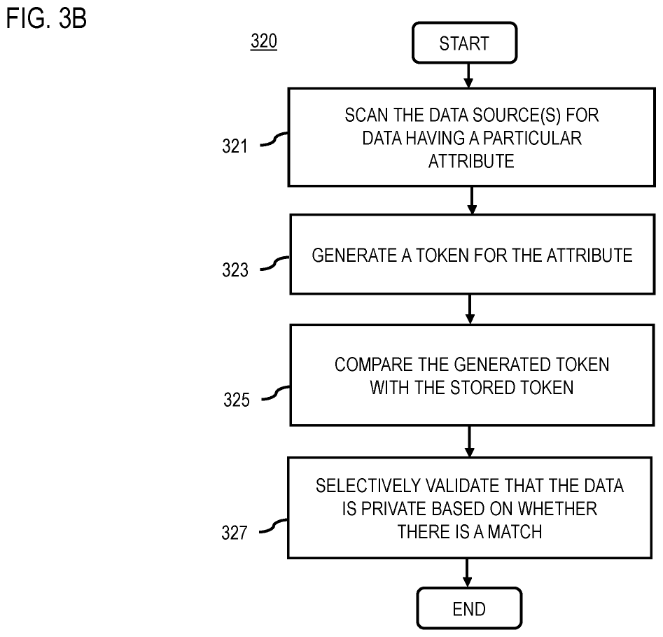

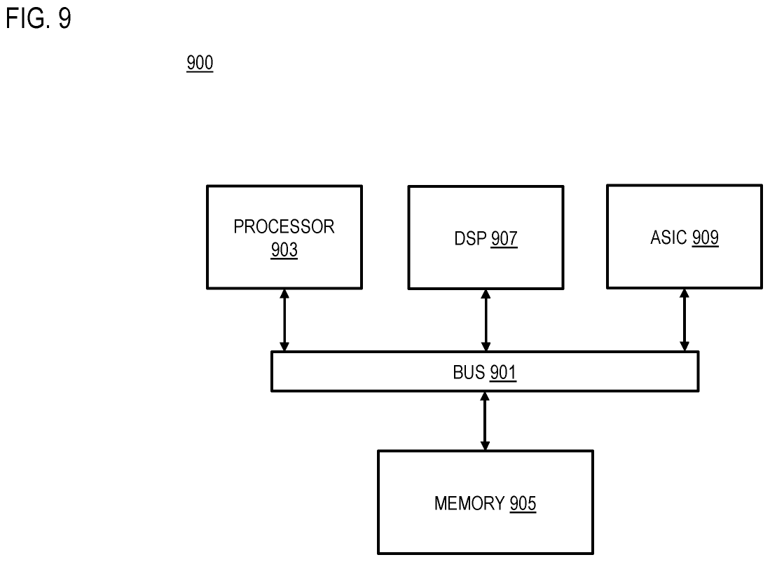

FIGS. 3A and 3B are flowcharts of a process for generating an adjustable ruleset for tokenization as part of fingerprinting data, and of a process for data discovery, according to various embodiments. In one embodiment, the private data discovery platform 109 performs the process 300 and is implemented in, for instance, a chip set including a processor and a memory as shown FIG. 9.

In step 301 (of FIG. 3A), the private data discovery platform 109 designates data with a particular data type as private. In one embodiment, a private data type requires authorization or approval for accessing data with the private data type. Per step 303, the private data discovery platform 109 collects data relating to at least one user from one or more data sources; such data sources may be within the network domain of the platform 109 as well as other specified domains to which the platform 109 has access (e.g., services platform 113). In one embodiment, the collected data includes private information of a user; the private information may be in form of an attribute of a data record; that is, the data record contains multiple attributes—anyone of the attributes can be designated as private. It is noted that if one attribute of the data record is private, then the data (or data record) is deemed private. By way of example, the private information includes, but is not limited to, social security number (SSN), date of birth (DOB) information, medical information, financial information, employment information, educational information, location information, family information, etc. In one embodiment, the data collection method includes, but is not limited to, web crawling technology, data mining technology, data extraction technology, data search via scanner, etc.

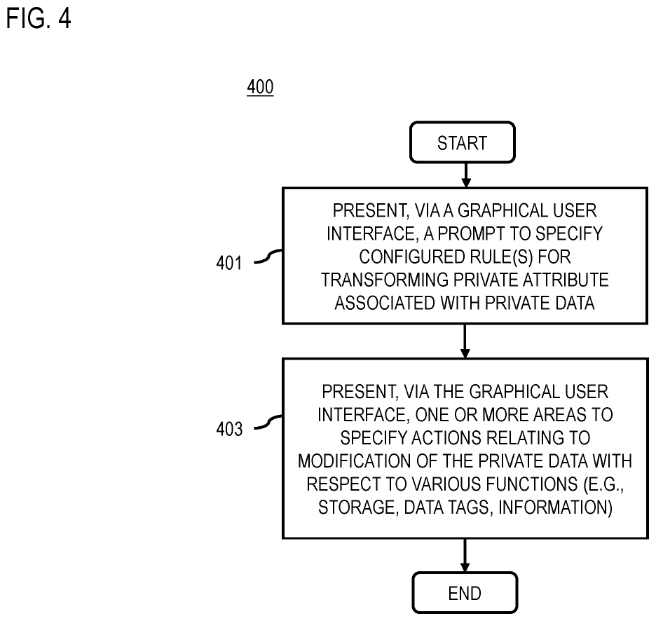

In step 305, the private data discovery platform 109 processes the collected data to transform the associated private attribute for tokenization. For example, in the case that the private attribute is a string of characters, the transformation may involve removal of designated characters (e.g., whitespace characters) based on one or more configured rules. In one embodiment, the whitespace characters include a space, a tab character, a newline character, punctuation, or a combination thereof. In one embodiment, the configured rules are rulesets specified by at least one user (further detailed in FIG. 4). In one example embodiment, the private data discovery platform 109 collects data in their original format for a user, e.g., SSN 123-45-6789 and DOB 04/11/80. The private data discovery platform 109 then processes the collected data to remove the whitespace characters according to the configured rules, thereby resulting in 123456789 as the SSN, and 041180 as the DOB.

In step 307, the private data discovery platform 109 generates a token (e.g., a hash value) corresponding to of the private attribute of the processed data. In one embodiment, the hash value is a numeric value of a fixed length that uniquely identifies the data—e.g., the private attribute. Thus, upon the private data discovery platform 109 applying a transformation function/scheme (e.g., hash function) to obfuscate the private attribute of the collected data, this token serves, in effect, as a digital fingerprint of the data. The hash function/scheme substitutes and transposes the original data to create the resulting hash.

In one example embodiment, the private data discovery platform 109 may implement a token builder, e.g., hashing algorithm, to configure the hashing rule set to generate hash values. The token builder can be implemented as a software application that controls the generation of the hash. In one embodiment, the private data discovery platform 109 implements user configurable rules for hash building. In this manner, the inflexibility of traditional hardcoded hashes is advantageously overcome. For example, rules can be grouped into sets of rules, where the individual rules describe what data elements to use for the hash, how to process each element, and how the elements fit in the resulting hash.

In step 309, the private data discovery platform 109 initiates storage of the token (e.g., hash value) within the fingerprinting database 111. The stored token is then subsequently utilized for data discovery, as next explained.

As shown in FIG. 3B, the data source(s) for data having a particular attribute, which is not known to be private, per step 321. In step 323, the particular attribute is tokenized, e.g., using the same transformation function/scheme described with respect to FIG. 3A. The newly generated token is then compared to the stored token, as in step 325. The platform 109, per step 327, selectively validates that the scanned data indeed is private data based on the private attribute having a matching token with the stored token.

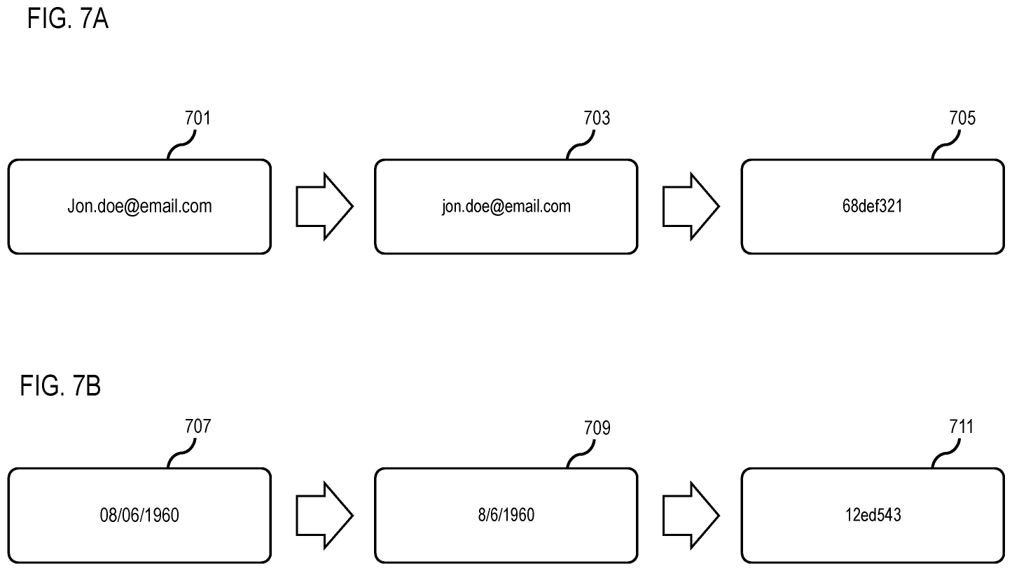

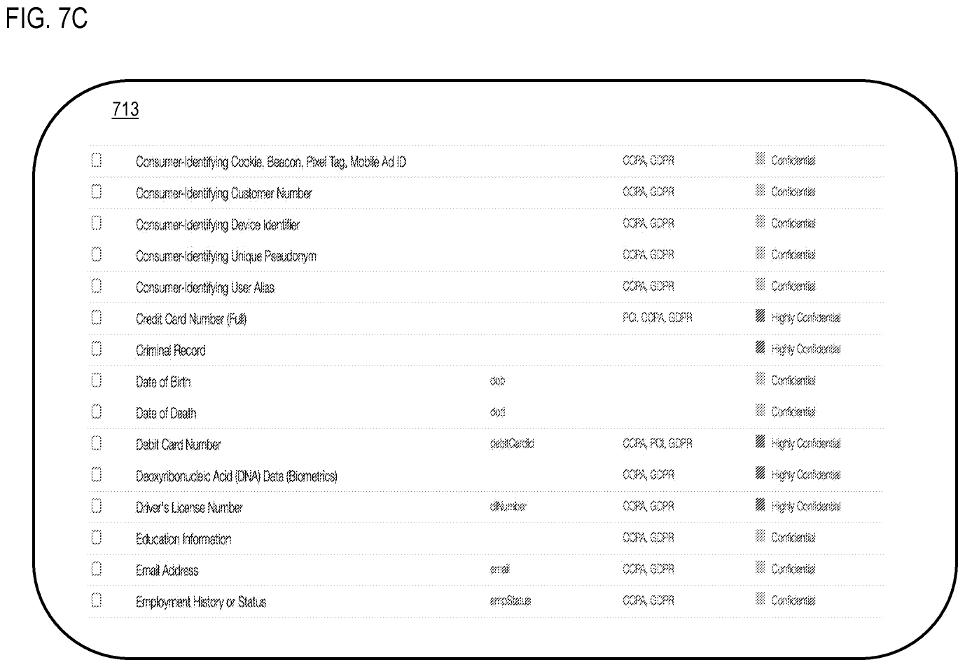

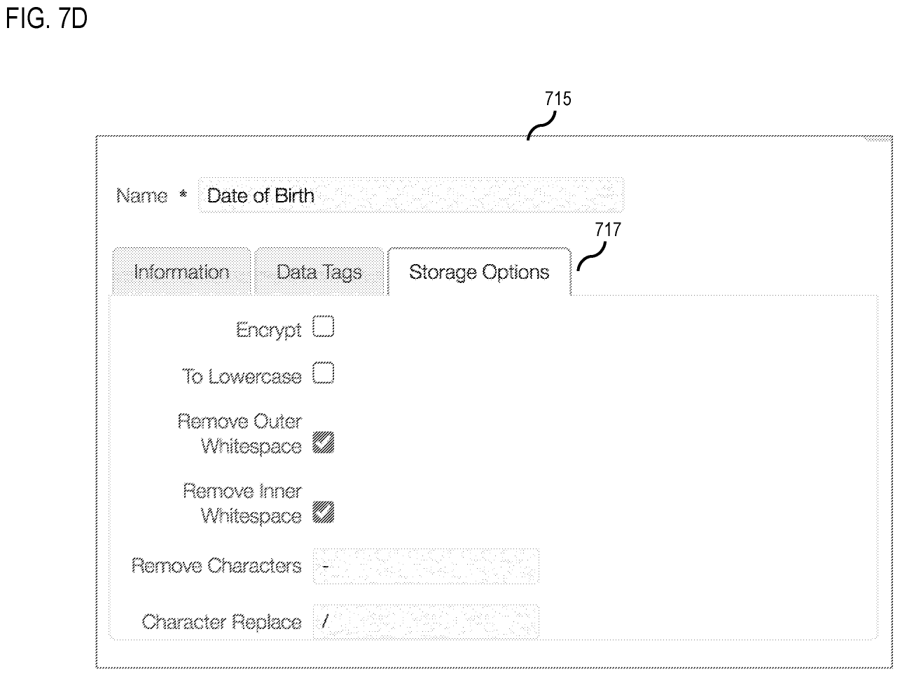

FIG. 4 is a flowchart of a process for configuring rules to tokenize private data, according to one embodiment. Under this embodiment, the platform 109 supports the capability to specify one or more configured rules for transforming a private attribute using a graphical user interface (GUI). By way of example, the GUI can be presented via the UE 101a to a user, e.g., an administrator of the platform 109. The GUI can provide a prompt, as in step 401, for the user to select a pre-configured rule or create a new configured rule to transform one or more attributes of a data record; an example is shown in FIG. 7C. That is, the private data discovery platform 109 may generate a user interface element (e.g., icon, text box, etc.) to specify or create the or more configured rules; by way of example, such rules may be in form of a pull down list of selectable rules. In addition, according to yet another embodiment, the GUI includes one or more areas/sections in form of tabs to allow the user to indicate actions relating to the modification of the private data with respect to various functions/actions—e.g., storage of the private data, data tags associated with the private data, or other information relating to the private data. Such areas specifying the actions relating to modification of the private data are presented, per step 403. An exemplary scenario is described with respect to FIG. 7D. In one embodiment, the actions include performing encryption, changing case of the characters of the string, removal of whitespaces, removal of one or more of the characters, replacement of the one or more characters, text manipulation, or a combination thereof.

The private data discovery platform 109 employs various application programming interfaces (APIs) or other function calls corresponding to the application 103 of UE 101; thus enabling the display of graphics primitives such as menus, data entry fields, etc., for generating the user interface elements. Still further, the private data discovery platform 109 may be configured to operate in connection with augmented reality (AR) processing techniques, wherein various different applications, graphic elements, and features may interact. In various embodiments, the private data discovery platform 109 may receive user selections to set or otherwise configure rules via the UE 101 such as a touch screen, a touchpad, a button/switch, speech recognition (e.g., capturing a voice command), gesture recognition (capturing a user gesture), etc.

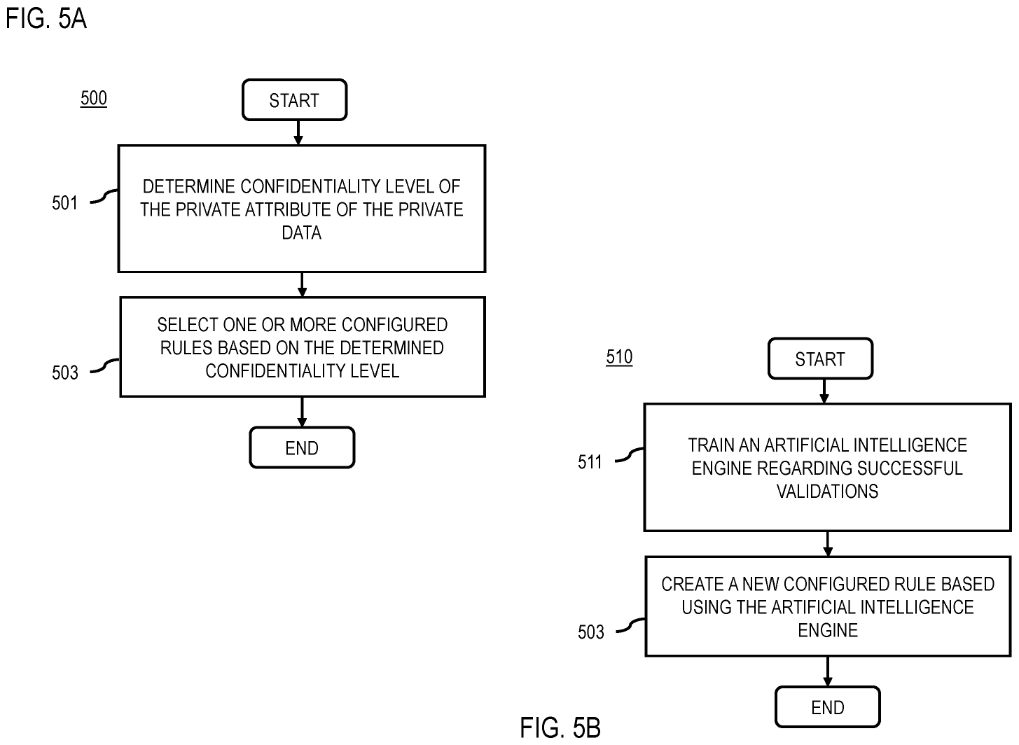

FIGS. 5A and 5B are flowcharts of a process for selecting configured rule(s) based on confidentiality level, and of a process for creating a new configured rule using an artificial intelligence engine, according to various embodiments. In one embodiment, the private data discovery platform 109 performs the process 500 and is implemented in, for instance, a chip set including a processor and a memory as shown FIG. 9.

In step 501, the private data discovery platform 109 can determine a confidentiality level of the private attribute as it applies to the data type. In one embodiment, the confidentiality level can binary, e.g., low and high, or be any number of levels based on the application. By way of example, the data type includes, but is not limited to, personal data, financial data, medical data, contextual data, employment data, etc., pertaining to at least one user. It is noted that the data type is provided by way of illustration and not as limitations, it is contemplated that any other data type can be used according to the embodiments described herein. In one embodiment, the private data discovery platform 109 may determine the confidentiality level of data based on the data types, e.g., the private data discovery platform 109 may set the predetermined, configurable privacy level to one of differing levels of increasing degree of sensitivity or confidentiality (e.g., “high”) or adjust the privacy level to the highest level for personal data, financial data and/or medical data associated with the user. In one embodiment, the private data discovery platform 109 may allow non-confidential and/or less sensitive information to be communicated via a less trustworthy network connection, whereas highly confidential information may only be disseminated through a secured network connection. In step 503, the configured rule(s) may be configured base on the determined confidentiality level.

As noted above, the platform 109 provides for an artificial intelligence (AI) engine (e.g., machine learning module 211) to assist with the modification or creation of the rules. As shown in FIG. 5B, the AI engine (module 211) in conjunction with the training module 209, is trained regarding the successful validations associated with the scans, per step 511. Once trained, the platform 109 can produce new configured rules without direct intervention from a human user (step 503).

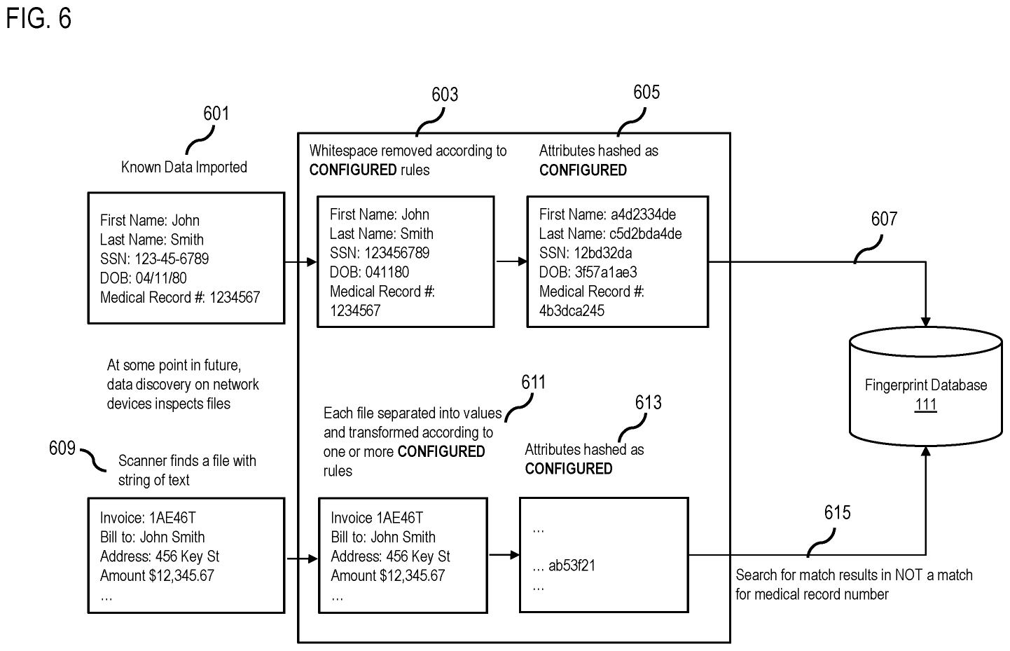

FIG. 6 is a diagram that shows a use case for the processes of FIGS. 3A and 3B, according to various embodiments. In step 601, the private data discovery platform 109 imports known data for one or more users. In one embodiment, the rulesets can be configured organically over time by machine learning or other artificial intelligence algorithms. In another embodiment, the private data discovery platform 109 implements a UI and repository of configurable rulesets specified by users/engineers instead of a hard-coded one-size-fits-all approach. Such configuration of individual data types per user preferences, machine learning, artificial intelligence algorithms, or as situations dictate enables more accurate fingerprinting of data and allows discovery tools to more accurately automate validation of known private data.

In step 603, the imported data is processed by the private data discovery platform 109 to remove various characters, e.g., whitespaces, based on configured rulesets. Thereafter, in step 605, the attributes of the processed data are tokenized (e.g., hashed) by the private data discovery platform 109 using such configured rulesets. Thereafter, the private data discovery platform 109 stores the modified data in a database, e.g., a fingerprint database 111 (step 607).

Next, in step 609, the data discovery process is performed, e.g., using a scanner or other network devices to inspect files to find another set of data, e.g., a string of text, associated with the particular user. In step 611, the private data discovery platform 109 processes and modifies the discovered data, e.g., separated into values, remove whitespaces, according to the one or more configured rules. Thereafter, in step 613, the attributes of the data are tokenized (e.g., hashed) per the configured rulesets. Subsequently, in step 615, the modified data is transmitted to the fingerprint database 111. A search for a match is performed; and the match is considered successful if the tokens (e.g., hash values) are the same. As depicted in FIG. 6, the dollar amount, i.e., $12,345.67, in the invoice contains the same numbers as the medical record number, i.e., 1234567. However, in steps 603 and 611, the private data discovery platform 109 transforms the medical record number and dollar amount according to the configured rules, e.g., the transformation (according to the configured rule) does not call for the removal of special characters. Therefore, unique strings in the dollar amount in the invoice and the medical record number produce different hash values, thereby resulting in no match.

FIGS. 7A and 7B are diagrams that illustrate two use cases for private data transformation, according to various embodiments. As depicted in FIG. 7A, the private data discovery platform 109 receives/collects a data element, e.g., email address, associated with an individual/user (step 701). That is, the data type is an email address. The private data discovery platform 109 processes, for instance, an email address (“Jon.doe@email.com) and determines at least one upper case character and then changes the uppercase character to a lowercase (step 703). That is, the ruleset configured for the treatment of emails converts all uppercase characters to their lowercase form, thereby having the uppercase and lowercase character pairs be in the same equivalence class. Subsequently, in step 705, the attributes of the data in lowercase form are hashed per the configured rulesets and then stored in the fingerprint database 111.

As depicted in FIG. 7B, the private data discovery platform 109 receives/collects a data element, with a data type of Date of Birth (DOB) of a particular individual (step 707). The private data discovery platform 109 processes the date of birth to determine symbols, e.g., /, and digits, e.g., leading zero in months and days, for deletion. Thereafter, the private data discovery platform 109 deletes the determined symbols and digits (step 709), i.e., the date of birth ruleset configured by a user deletes symbols, e.g., “/”, and digits, e.g., leading zero in months and days so that the digits are in the same equivalence class. Subsequently, in step 711, the attributes of the digits are hashed per the configured rulesets and then stored in the fingerprint database 111 for subsequent discovery or searching.

FIG. 7C is a diagram of a user interface that provides the data types for rules configuration, according to various embodiments. It is noted that the data type provided in user interface 713 is by way of illustration and not as limitations, it is contemplated that any other data type can be used according to the embodiments described herein. As depicted, the data type includes, e.g., personal data, financial data, medical data, educational data, contextual data, employment data, etc., pertaining to a user. The user can select the data type from the user interface 713 to configure a ruleset, as shown in Table 1:

TABLE 1

| Data Type Description | Privacy Level |
|---|---|
| Consumer-Identifying Cookie | Confidential |
| Consumer-Identifying Customer Number | Confidential |
| Consumer-Identifying Unique Pseudonym | Confidential |
| Consumer-Identifying User Alias | Confidential |
| Credit/Debit Card Number (Full) | Highly Confidential |
| Criminal Record | Highly Confidential |
| Date of Birth | Confidential |
| Date of Death | Confidential |
| DNA/Biometric Data | Highly Confidential |
| Driver's License Number | Highly Confidential |
| Education Information | Confidential |
| Email Address | Confidential |
| Employment History or Status | Confidential |

FIG. 7D is a diagram of a user interface that supports the configuration of a ruleset for tokenization, according to various embodiments. It is noted that the configuration of the ruleset provided in user interface 715 is by way of illustration and not as limitations, it is contemplated that any other ruleset can be configured according to the embodiments described herein. As depicted, a ruleset for a data element, e.g., date of birth (DOB), can be configured by selecting one or more options from the user interface 715. For this data element, one or more tabs 717 permit the administrator to specify different rules to be applied for: Storage Options, Data Tags, and Information. In one example embodiment, the configured ruleset may be specified to remove, e.g., outer whitespace and inner white space for a certain data element. Additionally, the configured rule may specify encryption and modification to lowercase form for certain data elements (e.g., strings). Within the Storage Options tab, the following icons/buttons are provided to enable the following functions: “Encrypt” function for activating the encryption of the DOB information; “To Lowercase” function for converting any capitalized letters to lowercase; “Remove Outer Whitespace” function for deleting whitespaces outside the string; “Remove Inner Whitespace” function for deleting whitespaces within the string; “Remove Characters” box for specifying the particular character(s) to delete from the string; and a “Character Replace” box for specifying a character to replace. In this example, according to the rules selected for the Storage Options, the DOB data element will have both outer and inner whitespaces removed, and the character “-” is replaced by “/”; thus, a string such as “09-22-86” would be transformed to “09/22/86”. Consequently, the data will be stored in the fingerprint database 111 in this format.

The processes described herein for generating an adjustable ruleset for fingerprinting data may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

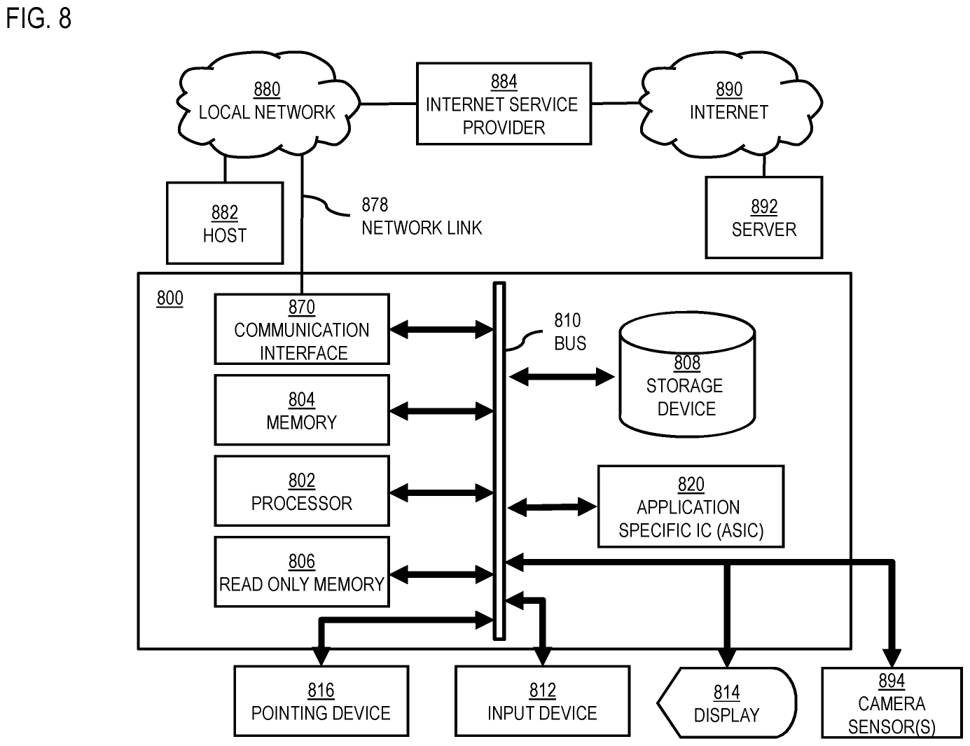

FIG. 8 illustrates a computer system 800 upon which an embodiment of the invention may be implemented. Although computer system 800 is depicted with respect to a particular device or equipment, it is contemplated that other devices or equipment (e.g., network elements, servers, etc.) within FIG. 8 can deploy the illustrated hardware and components of system 800. Computer system 800 is programmed (e.g., via computer program code or instructions) to generate an adjustable ruleset for fingerprinting data as described herein and includes a communication mechanism such as a bus 810 for passing information between other internal and external components of the computer system 800. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 810 includes one or more parallel conductors of information so that information is transferred quickly among devices coupled to the bus 810. One or more processors 802 for processing information are coupled with the bus 810.

A processor (or multiple processors) 802 performs a set of operations on information as specified by computer program code related to generate an adjustable ruleset for fingerprinting data. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 810 and placing information on the bus 810. The set of operations also typically include comparing two or more units of information, shifting positions of units of information, and combining two or more units of information, such as by addition or multiplication or logical operations like OR, exclusive OR (XOR), and. Each operation of the set of operations that can be performed by the processor is represented to the processor by information called instructions, such as an operation code of one or more digits. A sequence of operations to be executed by the processor 802, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 800 also includes a memory 804 coupled to bus 810. The memory 804, such as a random access memory (RAM) or other dynamic storage device, stores information including processor instructions for generating an adjustable ruleset for fingerprinting data. Dynamic memory allows information stored therein to be changed by the computer system 800. RAM allows a unit of information stored at a location called a memory address to be stored and retrieved independently of information at neighboring addresses. The memory 804 is also used by the processor 802 to store temporary values during execution of processor instructions. The computer system 800 also includes a read only memory (ROM) 806 or other static storage device coupled to the bus 810 for storing static information, including instructions, that is not changed by the computer system 800. Some memory is composed of volatile storage that loses the information stored thereon when power is lost. Also coupled to bus 810 is a non-volatile (persistent) storage device 808, such as a magnetic disk, optical disk or flash card, for storing information, including instructions, that persists even when the computer system 800 is turned off or otherwise loses power.

Information, including instructions for generating an adjustable ruleset for fingerprinting data, is provided to the bus 810 for use by the processor from an external input device 812, such as a keyboard containing alphanumeric keys operated by a human user, or a sensor. A sensor detects conditions in its vicinity and transforms those detections into physical expression compatible with the measurable phenomenon used to represent information in computer system 800. Other external devices coupled to bus 810, used primarily for interacting with humans, include a display device 814, such as a cathode ray tube (CRT) or a liquid crystal display (LCD), or plasma screen or printer for presenting text or images, and a pointing device 816, such as a mouse or a trackball or cursor direction keys, or motion sensor, for controlling a position of a small cursor image presented on the display 814 and issuing commands associated with graphical elements presented on the display 814, and one or more camera sensors 894 for capturing, recording and causing to store one or more still and/or moving images (e.g., videos, movies, etc.) which also may comprise audio recordings. In some embodiments, for example, in embodiments in which the computer system 800 performs all functions automatically without human input, one or more of external input device 812, display device 814 and pointing device 816 is omitted.

In the illustrated embodiment, special purpose hardware, such as an application specific integrated circuit (ASIC) 820, is coupled to bus 810. The special purpose hardware is configured to perform operations not performed by processor 802 quickly enough for special purposes. Examples of application specific ICs include graphics accelerator cards for generating images for display 814, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 800 also includes one or more instances of a communications interface 870 coupled to bus 810. Communication interface 870 provides a one-way or two-way communication coupling to a variety of external devices that operate with their own processors, such as printers, scanners, and external disks. In general, the coupling is with a network link 878 that is connected to a local network 880 to which a variety of external devices with their own processors are connected. For example, communication interface 870 may be a parallel port or a serial port or a universal serial bus (USB) port on a personal computer. In some embodiments, communications interface 870 is an integrated services digital network (ISDN) card or a digital subscriber line (DSL) card or a telephone modem that provides an information communication connection to a corresponding type of telephone line. In some embodiments, a communication interface 870 is a cable modem that converts signals on bus 810 into signals for a communication connection over a coaxial cable or into optical signals for a communication connection over a fiber optic cable. As another example, communications interface 870 may be a local area network (LAN) card to provide a data communication connection to a compatible LAN, such as Ethernet. Wireless links may also be implemented. For wireless links, the communications interface 870 sends or receives or both sends and receives electrical, acoustic or electromagnetic signals, including infrared and optical signals, that carry information streams, such as digital data. For example, in wireless handheld devices, such as mobile telephones like cell phones, the communications interface 870 includes a radio band electromagnetic transmitter and receiver called a radio transceiver. In certain embodiments, the communications interface 870 enables connection to the communication network 107 for generating an adjustable ruleset for fingerprinting data to the UE 101.

The term “computer-readable medium” is used herein to refer to any medium that participates in providing information to processor 802, including instructions for execution. Such a medium may take many forms, including, but not limited to, computer-readable storage medium (e.g., non-volatile media, volatile media), and transmission media. Non-volatile media include, for example, optical or magnetic disks, such as storage device 808. Volatile media include, for example, dynamic memory 804. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization, or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 820.

Network link 878 typically provides information communication using transmission media through one or more networks to other devices that use or process the information. For example, network link 878 may provide a connection through local network 880 to a host computer 882 or to equipment 884 operated by an Internet Service Provider (ISP). ISP equipment 884 in turn provides data communication services through the public, world-wide packet-switching communication network of networks now commonly referred to as the Internet 890.

A computer called a server host 892 connected to the Internet hosts a process that provides a service in response to information received over the Internet. For example, server host 892 hosts a process that provides information representing video data for presentation at display 814. It is contemplated that the components of system can be deployed in various configurations within other computer systems, e.g., host 882 and server 892.

At least some embodiments of the invention are related to the use of computer system 800 for implementing some or all of the techniques described herein. According to one embodiment of the invention, those techniques are performed by computer system 800 in response to processor 802 executing one or more sequences of one or more processor instructions contained in memory 804. Such instructions, also called computer instructions, software and program code, may be read into memory 804 from another computer-readable medium such as storage device 808 or network link 878. Execution of the sequences of instructions contained in memory 804 causes processor 802 to perform one or more of the method steps described herein. In alternative embodiments, hardware, such as ASIC 820, may be used in place of or in combination with software to implement the invention. Thus, embodiments of the invention are not limited to any specific combination of hardware and software, unless otherwise explicitly stated herein.

The signals transmitted over network link 878 and other networks through communications interface 870, carry information to and from computer system 800. Computer system 800 can send and receive information, including program code, through the networks 880, 890 among others, through network link 878 and communications interface 870. In an example using the Internet 890, a server host 892 transmits program code for a particular application, requested by a message sent from computer 800, through Internet 890, ISP equipment 884, local network 880 and communications interface 870. The received code may be executed by processor 802 as it is received, or may be stored in memory 804 or in storage device 808 or any other non-volatile storage for later execution, or both. In this manner, computer system 800 may obtain application program code in the form of signals on a carrier wave.

Various forms of computer readable media may be involved in carrying one or more sequence of instructions or data or both to processor 802 for execution. For example, instructions and data may initially be carried on a magnetic disk of a remote computer such as host 882. The remote computer loads the instructions and data into its dynamic memory and sends the instructions and data over a telephone line using a modem. A modem local to the computer system 800 receives the instructions and data on a telephone line and uses an infra-red transmitter to convert the instructions and data to a signal on an infra-red carrier wave serving as the network link 878. An infrared detector serving as communications interface 870 receives the instructions and data carried in the infrared signal and places information representing the instructions and data onto bus 810. Bus 810 carries the information to memory 804 from which processor 802 retrieves and executes the instructions using some of the data sent with the instructions. The instructions and data received in memory 804 may optionally be stored on storage device 808, either before or after execution by the processor 802.

FIG. 9 illustrates a chip set 900 upon which an embodiment of the invention may be implemented. Chip set 900 is programmed to generate an adjustable ruleset for fingerprinting data as described herein and includes, for instance, the processor and memory components described with respect to FIG. 8 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. It is further contemplated that in certain embodiments the chip set or chip 900 can be implemented as a single “system on a chip.” It is further contemplated that in certain embodiments a separate ASIC would not be used, for example, and that all relevant functions as disclosed herein would be performed by a processor or processors. Chip set or chip 900, or a portion thereof, constitutes a means for performing one or more steps of providing user interface navigation information associated with the availability of functions.

In one embodiment, the chip set 900 includes a communication mechanism such as a bus 901 for passing information among the components of the chip set 900. A processor 903 has connectivity to the bus 901 to execute instructions and process information stored in, for example, a memory 905. The processor 903 may include one or more processing cores with each core configured to perform independently. A multi-core processor enables multiprocessing within a single physical package. Examples of a multi-core processor include two, four, eight, or greater numbers of processing cores. Alternatively or in addition, the processor 903 may include one or more microprocessors configured in tandem via the bus 901 to enable independent execution of instructions, pipelining, and multithreading. The processor 903 may also be accompanied with one or more specialized components to perform certain processing functions and tasks such as one or more digital signal processors (DSP) 907, or one or more application-specific integrated circuits (ASIC) 909. A DSP 907 typically is configured to process real-world signals (e.g., sound) in real time independently of the processor 903. Similarly, an ASIC 909 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

In one embodiment, the chip set or chip 900 includes merely one or more processors and some software and/or firmware supporting and/or relating to and/or for the one or more processors.

The processor 903 and accompanying components have connectivity to the memory 905 via the bus 901. The memory 905 includes both dynamic memory (e.g., RAM, magnetic disk, writable optical disk, etc.) and static memory (e.g., ROM, CD-ROM, etc.) for storing executable instructions that when executed perform the inventive steps described herein to generate an adjustable ruleset for fingerprinting data. The memory 905 also stores the data associated with or generated by the execution of the inventive steps.

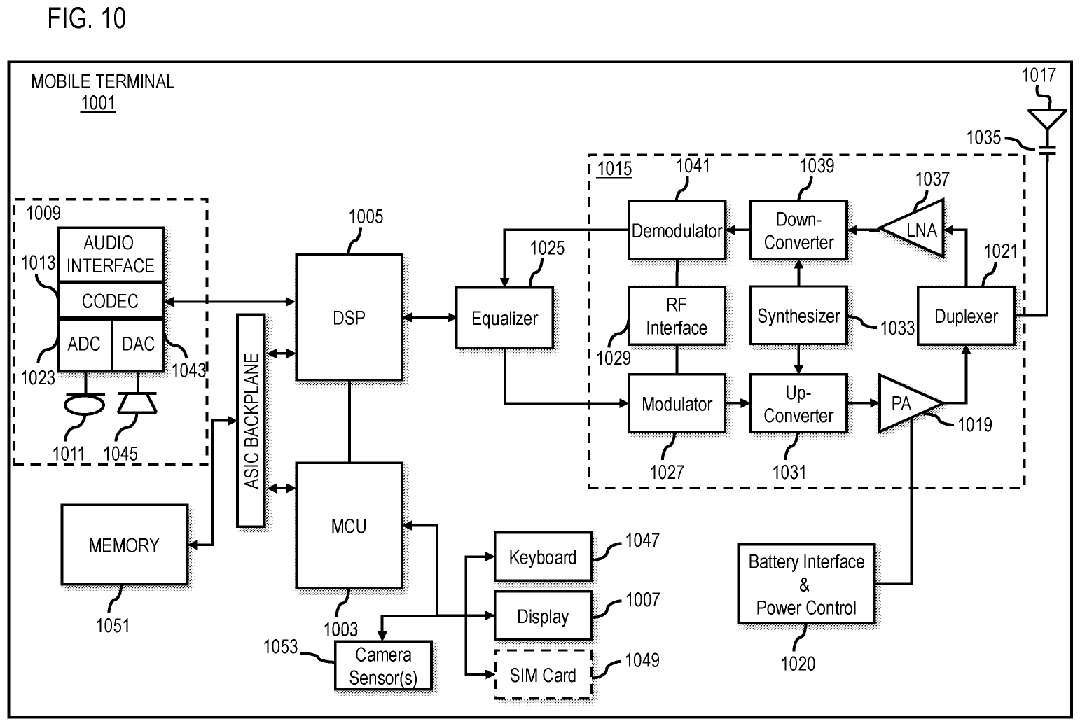

FIG. 10 is a diagram of exemplary components of a mobile terminal (e.g., handset) capable of operating in the system of FIG. 1, according to one embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1003, a Digital Signal Processor (DSP) 1005, and a receiver/transmitter unit including a microphone gain control unit and a speaker gain control unit. A main display unit 1007 provides a display to the user in support of various applications and mobile station functions that offer automatic contact matching. The display 1007 includes display circuitry configured to display at least a portion of a user interface of the mobile terminal (e.g., mobile telephone). Additionally, the display 1007 and display circuitry are configured to facilitate user control of at least some functions of the mobile terminal. An audio function circuitry 1009 includes a microphone 1011 and microphone amplifier that amplifies the speech signal output from the microphone 1011. The amplified speech signal output from the microphone 1011 is fed to a coder/decoder (CODEC) 1013.

A radio section 1015 amplifies power and converts frequency in order to communicate with a base station, which is included in a mobile communication system, via antenna 1017. The power amplifier (PA) 1019 and the transmitter/modulation circuitry are operationally responsive to the MCU 1003, with an output from the PA 1019 coupled to the duplexer 1021 or circulator or antenna switch, as known in the art. The PA 1019 also couples to a battery interface and power control unit 1020.

In use, a user of mobile station 1001 speaks into the microphone 1011 and his or her voice along with any detected background noise is converted into an analog voltage. The analog voltage is then converted into a digital signal through the Analog to Digital Converter (ADC) 1023. The control unit 1003 routes the digital signal into the DSP 1005 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like.

The encoded signals are then routed to an equalizer 1025 for compensation of any frequency-dependent impairments that occur during transmission though the air such as phase and amplitude distortion. After equalizing the bit stream, the modulator 1027 combines the signal with a RF signal generated in the RF interface 1029. The modulator 1027 generates a sine wave by way of frequency or phase modulation. In order to prepare the signal for transmission, an up-converter 1031 combines the sine wave output from the modulator 1027 with another sine wave generated by a synthesizer 1033 to achieve the desired frequency of transmission. The signal is then sent through a PA 1019 to increase the signal to an appropriate power level. In practical systems, the PA 1019 acts as a variable gain amplifier whose gain is controlled by the DSP 1005 from information received from a network base station. The signal is then filtered within the duplexer 1021 and optionally sent to an antenna coupler 1035 to match impedances to provide maximum power transfer. Finally, the signal is transmitted via antenna 1017 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 1001 are received via antenna 1017 and immediately amplified by a low noise amplifier (LNA) 1037. A down-converter 1039 lowers the carrier frequency while the demodulator 1041 strips away the RF leaving only a digital bit stream. The signal then goes through the equalizer 1025 and is processed by the DSP 1005. A Digital to Analog Converter (DAC) 1043 converts the signal and the resulting output is transmitted to the user through the speaker 1045, all under control of a Main Control Unit (MCU) 1003—which can be implemented as a Central Processing Unit (CPU) (not shown).

The MCU 1003 receives various signals including input signals from the keyboard 1047. The keyboard 1047 and/or the MCU 1003 in combination with other user input components (e.g., the microphone 1011) comprise a user interface circuitry for managing user input. The MCU 1003 runs a user interface software to facilitate user control of at least some functions of the mobile station 1001 to generate an adjustable ruleset for fingerprinting data. The MCU 1003 also delivers a display command and a switch command to the display 1007 and to the speech output switching controller, respectively. Further, the MCU 1003 exchanges information with the DSP 1005 and can access an optionally incorporated SIM card 1049 and a memory 1051. In addition, the MCU 1003 executes various control functions required of the station. The DSP 1005 may, depending upon the implementation, perform any of a variety of conventional digital processing functions on the voice signals. Additionally, DSP 1005 determines the background noise level of the local environment from the signals detected by microphone 1011 and sets the gain of microphone 1011 to a level selected to compensate for the natural tendency of the user of the mobile station 1001.

The CODEC 1013 includes the ADC 1023 and DAC 1043. The memory 1051 stores various data including call incoming tone data and is capable of storing other data including music data received via, e.g., the global Internet. The software module could reside in RAM memory, flash memory, registers, or any other form of writable computer-readable storage medium known in the art. The memory device 1051 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1049 carries, for instance, important information, such as the cellular phone number, the carrier supplying service, subscription details, and security information. The SIM card 1049 serves primarily to identify the mobile station 1001 on a radio network. The card 1049 also contains a memory for storing a personal telephone number registry, text messages, and user specific mobile station settings.

Further, one or more camera sensors 1053 may be incorporated onto the mobile station 1001 wherein the one or more camera sensors may be placed at one or more locations on the mobile station. Generally, the camera sensors may be utilized to capture, record, and cause to store one or more still and/or moving images (e.g., videos, movies, etc.) which also may comprise audio recordings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
designating a data type as private;
collecting private data relating to a user from one or more data sources, wherein the private data includes a plurality of attributes that include a private attribute having the private data type;
transforming the private attribute based on one or more configured rules for tokenizing the private attribute;
generating a token corresponding to the transformed private attribute; and
initiating storage of the token for subsequent discovery of data having the private data type.

2. The method of claim 1, wherein the private data type requires authorization for accessing data with the private data type, the method further comprising:
applying a hash function to the transformed private attribute to generate the token.

3. The method of claim 1, wherein the private attribute is a string of characters, the method further comprising:
presenting, via a graphical user interface, a prompt to specify the configured rule for transforming the private attribute, wherein the configured rule specifies removal, addition, or modification of one or more characters of the private attribute.

4. The method of claim 3, wherein the graphical user interface includes:
a storage option area to specify a plurality of actions relating to storing the private attribute within a database, wherein the plurality of actions include an encryption, changing case of the characters of the string, removal of whitespaces, removal of one or more of the characters, replacement of the one or more characters, text manipulation, or a combination thereof.

5. The method of claim 1, further comprising:
scanning the one or more data sources for other data with the private data type, wherein the other data includes another attribute;
generating another token for the other attribute;
comparing the other token with the stored token to determine whether a match exists; and
selectively validating that the other data is private based on the match.

6. The method of claim 5, further comprising:
training an artificial intelligence engine regarding successful validations; and
creating a new configured rule using the artificial intelligence engine.

7. The method of claim 1, further comprising:
determining confidentiality level of the private attribute; and
selecting the one or more configured rules based on the determined confidentiality level.

8. An apparatus comprising:
at least one processor; and
at least one memory including computer program code for one or more programs,
the at least one memory and the computer program code configured to, with the at least one processor, cause the apparatus to perform the following,
designate a data type as private;
collect private data relating to a user from one or more data sources, wherein the private data includes a plurality of attributes that include a private attribute having the private data type;
transform the private attribute based on one or more configured rules for tokenizing the private attribute;
generate a token corresponding to the transformed private attribute; and
initiate storage of the token for subsequent discovery of data having the private data type.

9. The apparatus of claim 8, wherein the private data type requires authorization for accessing data with the private data type, the apparatus further comprising:
apply a hash function to the transformed private attribute to generate the token.

10. The apparatus of claim 8, wherein the private attribute is a string of characters, the apparatus being further caused to perform the following:
present, via a graphical user interface, a prompt to specify the configured rule for transforming the private attribute, wherein the configured rule specifies removal, addition, or modification of one or more characters of the private attribute.

11. The apparatus of claim 10, wherein the graphical user interface includes:
a storage option area to specify a plurality of actions relating to storing the private attribute within a database, wherein the plurality of actions include an encryption, changing case of the characters of the string, removal of whitespaces, removal of one or more of the characters, replacement of the one or more characters, text manipulation, or a combination thereof.

12. The apparatus of claim 8, being further caused to perform the following:
scan the one or more data sources for other data with the private data type, wherein the other data includes another attribute;
generate another token for the other attribute;
compare the other token with the stored token to determine whether a match exists; and
selectively validate that the other data is private based on the match.

13. The apparatus of claim 12, being further caused to perform the following:
train an artificial intelligence engine regarding successful validations; and
create a new configured rule using the artificial intelligence engine.

14. The apparatus of claim 8, being further caused to perform the following:
determine confidentiality level of the private attribute; and
select the one or more configured rules based on the determined confidentiality level.

15. A system comprising:
one or more servers configured to perform the following,
designate a data type as private;
collect private data relating to a user from one or more data sources, wherein the private data includes a plurality of attributes that include a private attribute having the private data type;
transform the private attribute based on one or more configured rules for tokenizing the private attribute;
generate a token corresponding to the transformed private attribute; and
initiate storage of the token for subsequent discovery of data having the private data type.

16. The system of claim 15, wherein the private data type requires authorization for accessing data with the private data type, the one or more servers being further configure to:
determine confidentiality level of the private attribute;
select the one or more configured rules based on the determined confidentiality level; and
apply a hash function to the transformed private attribute to generate the token.

17. The system of claim 15, wherein the private attribute is a string of characters, the one or more servers being further configured to:
present, via a graphical user interface, a prompt to specify the configured rule for transforming the private attribute, wherein the configured rule specifies removal, addition, or modification of one or more characters of the private attribute.

18. The system of claim 17, wherein the graphical user interface includes:
a storage option area to specify a plurality of actions relating to storing the private attribute within a database, wherein the plurality of actions include an encryption, changing case of the characters of the string, removal of whitespaces, removal of one or more of the characters, replacement of the one or more characters, text manipulation, or a combination thereof.

19. The system of claim 15, wherein the one or more servers are further configured to:
scan the one or more data sources for other data with the private data type, wherein the other data includes another attribute;
generate another token for the other attribute;
compare the other token with the stored token to determine whether a match exists; and
selectively validate that the other data is private based on the match.

20. The system of claim 19, wherein the one or more servers are further configured to:
train an artificial intelligence engine regarding successful validations; and
create a new configured rule using the artificial intelligence engine.
